(19) United States
(12) Patent Application Publication
(10) Pub. No.: US 2022/0206213 A1
(43) Pub. Date: Jun. 30, 2022

(54) PLASTIC OPTICAL FIBER MANUFACTURING METHOD

(71) Applicant: NITTO DENKO CORPORATION, Ibaraki-shi, Osaka (JP)

(72) Inventors: Yoshihide Kawaguchi, Osaka (JP); Tatsuya Araki, Osaka (JP); Kenjiro Saomoto, Osaka (JP); Kanji Nishida, Osaka (JP)

(73) Assignee: NITTO DENKO CORPORATION, Ibaraki-shi, Osaka (JP)

(21) Appl. No.: 17/602,467

(22) PCT Filed: Apr. 10, 2020
(86) PCT No.: PCT/JP2020/016168

§ 371 Date: Oct. 8, 2021

(30) Foreign Application Priority Data
Apr. 12, 2019 (JP) 2019-076518

(51) Int. Cl. G02B 6/02; D01D 4/02; D01D 5/10

(52) U.S. Cl. CPC G02B 6/02033; D01D 4/022; D10B 2401/20; D10B 2321/042; D01D 5/10

(57) ABSTRACT

A method is disclosed including causing a preform 1 that is softened to pass from an inner side of a container-shaped member 10 having a shape of a container having a through hole 12 at a bottom thereof through the through hole 12. The preform 1 includes a resin. At least an inner surface 10i of the container-shaped member 10 is formed of a material including glass, a heat-resistant resin, or aluminum as a main component. In one embodiment of the present invention, the preform 1 is heated while the preform 1 and a metallic member 20 in which the container-shaped member 10 is disposed are not in direct contact with each other, and the preform 1 softened thereby is caused to pass through the through hole 12 and then through a tubular portion 26 of the metallic member 20 to shape the preform 1 into a fibrous shape.

### TECHNICAL FIELD

The present invention relates to a plastic optical fiber manufacturing method.

### BACKGROUND ART

Plastic optical fibers are excellent in terms of low manufacturing cost, high flexibility, and high processability compared to quartz glass optical fibers. Plastic optical fibers are chiefly used as transmission media for short-distance (for example, 100 m or less) use.

A plastic optical fiber commonly includes a core located in a central portion and configured to transmit light and a clad coating the outer circumference of the core, as a glass optical fiber does. The core of a plastic optical fiber is formed of a resin having a high refractive index, while the clad thereof is formed of a resin having a lower refractive index than that of the resin of the core.

Melt spinning involving a preform is known (for example, Patent Literature 1) as a plastic optical fiber manufacturing method. The preform may include a resin for forming a core and a resin for forming a clad, or may include only a resin for forming a core. When the preform includes only the resin for forming a core, a fibrous core is formed from the preform by melt spinning and is then coated with a resin for forming a clad to produce a plastic optical fiber. In melt spinning, a fibrous formed body is produced by disposing the preform inside a metallic member which is also called a spinning mold, applying heat to the preform via the metallic member, and causing the preform softened by the heating to pass through a tubular portion at a bottom of the metallic member. An alloy such as stainless steel or HASTELLOY is suitable for the material of the metallic member.

### CITATION LIST

### Patent Literature

Patent Literature 1: JP 2003-344675 A

### SUMMARY OF INVENTION

### Technical Problem

Plastic optical fibers are required to decrease their transmission losses. The present invention aims to provide a new method for manufacturing a plastic optical fiber suitable for decreasing transmission loss.

### Solution to Problem

Through intensive studies, the present inventors have found out that the factor causing an increase in transmission loss of a plastic optical fiber is, unexpectedly, contact between a preform and the material, such as stainless steel or HASTELLOY, of a metallic member used as a spinning mold. The present invention has been completed on the basis of this finding.

The present invention provides a plastic optical fiber manufacturing method including causing a preform that is softened to pass from an inner side of a container-shaped member having a shape of a container having a through hole at a bottom thereof through the through hole, wherein

the preform includes a resin, and

at least an inner surface of the container-shaped member is formed of a material including glass, a heat-resistant resin, or aluminum as a main component.

### Advantageous Effects of Invention

The present invention can provide a method for manufacturing a plastic optical fiber suitable for decreasing transmission loss.

### BRIEF DESCRIPTION OF DRAWINGS

FIG. 1 is a cross-sectional view showing an exemplary spinning mold (metallic member) of a spinning apparatus.

FIG. 2 is a cross-sectional view showing an exemplary container-shaped member.

FIG. 3 is a cross-sectional view showing an exemplary container.

FIG. 4 is a cross-sectional view showing another exemplary container.

FIG. 5 shows a state where a container-shaped member having a tubular portion derived from a projecting portion is disposed in a spinning mold.

FIG. 6 is a cross-sectional view showing an exemplary container having a through hole blocked by a sealing member.

FIG. 7 is a cross-sectional view showing another exemplary container having a through hole blocked by a sealing member.

FIG. 8 illustrates an exemplary spinning apparatus for accomplishing a manufacturing method of the present invention.

FIG. 9 shows a state where a container-shaped member having a tubular portion derived from a projecting portion is disposed in a spinning apparatus.

FIG. 10 shows a state where a preform is in direct contact with a spinning mold (metallic member) of a spinning apparatus.

### DESCRIPTION OF EMBODIMENTS

Hereinafter, an embodiment of the present invention will be described. The following description is not intended to limit the present invention to a specific embodiment. A container having a through hole at its bottom is herein referred to as “container-shaped member” for better distinction from a “container” having no through hole communicating with the outside and inside at its bottom. The term “inner surface” of a container-shaped member refers to a surface that faces the inside of the container when the through hole of the member is blocked to make the member into a container. The term “main component” is used herein as a term referring to a component whose content is highest on a weight basis, and the term “consist essentially of” a certain component is used herein as a term referring to a condition where the component accounts for 95 weight % (wt %) or more or even 99 wt % or more.

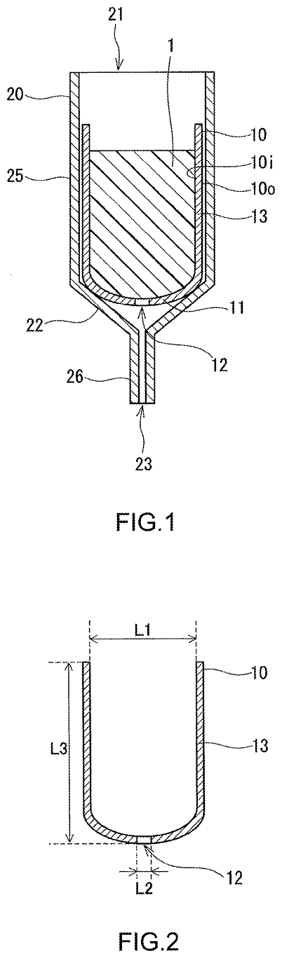

FIG. 1 is a cross-sectional view showing a metallic member 20 which is a spinning mold of a spinning apparatus. The metallic member 20 is a tubular member whose internal space communicates with the outside at a first opening portion 21 located on the upper side and a second opening portion 23 located on the lower side. A container-shaped member 10 is disposed in the internal space of the metallic member 20. A preform 1 of a plastic optical fiber (POF) is contained inside the container-shaped member 10.

The container-shaped member 10 is an open-top member with a bottom, the member having a bottom 11 and a side wall portion 13 extending upward from a periphery of the bottom 11. It should be noted that a through hole 12 is arranged at the bottom 11. The shape of the bottom 11 is not limited to a particular one. The bottom 11 has the shape of, for example, a polygon or a circle when viewed in plan and has the shape of, for example, a flat plate or a bent plate when viewed from the side. The bottom 11 shown in FIG. 1 has the shape of a bent plate when viewed from the side. Like this shape, the bottom 11 of the container-shaped member 10 is preferably in such a sagging shape that the bottom 11 gradually sags downward from the periphery connected to the side wall portion 13 toward the middle of the bottom 11. An upper surface of the bottom 11 shown in FIG. 1, the upper surface also serving as a bottom surface of the container-shaped member 10, forms a U-shaped curved line that is convex downward when viewed in a longitudinal section (refer to FIG. 1) of the member 10. When the member 10 is viewed from the side, it is the middle of the bottom 11, for example, the center of gravity of the bottom 11, that is located at the lowermost part of the bottom 11. It should be added that the upper surface of the bottom 11 may be, for example, V-shaped or stepped downward from the periphery to the middle. The side wall portion 13 preferably has a cylindrical shape.

The through hole 12 formed at the bottom 11 penetrates the bottom 11 in the thickness direction at the lowermost part of the bottom 11, i.e., in FIG. 1, at the middle (which is also the center of gravity) of the bottom 11. The through hole 12 preferably has the shape of a circle when viewed in plan.

At least an inner surface 10i of the container-shaped member 10 is formed of a material including glass, a heat-resistant resin, or aluminum as a main component. The material such as glass is advantageous because the material is less likely to deteriorate a resin included in the preform 1.

The material including glass as the main component is excellent in terms of, for example, ease of processing for formation of the through hole 12. The glass, for example, has composition including silica as the main component, and is preferably soda-lime glass, borosilicate glass, aluminosilicate glass, or the like. The heat-resistant resin is, for example, a fluorine resin, a polyimide resin, a polyamide resin, a polyetheretherketone resin, a polyetherimide resin, or a polyphenylene sulfide resin, and is preferably a fluorine resin. The material including a fluorine resin as the main component is excellent in terms of, for example, the mold releasability of the preform 1. The fluorine resin is preferably polytetrafluoroethylene (PTFE). The content of the glass, the heat-resistant resin, or aluminum is, for example, 50 weight % (wt %) or more, preferably 80 wt % or more, and more preferably 90 wt % or more in the container-shaped member 10. The container-shaped member 10 may consist essentially of the glass, the heat-resistant resin, or aluminum.

The container-shaped member 10 may be formed of a single-layer material or may be formed of a laminate material. The whole single-layer material is formed of the material including the glass, the heat-resistant resin, or aluminum as the main component. The laminate material is, for example, a laminate including an internal layer including the glass, the heat-resistant resin, or aluminum as the main component and a supporting layer supporting the internal layer from an outer surface 10o side of the container-shaped member 10. The internal layer forms the inner surface 10i in contact with the preform 1 in the container-shaped member 10. The internal layer is suitably a coating or thin layer including the glass, the heat-resistant resin, or aluminum as the main component, a film including the heat-resistant resin as the main component, an aluminum foil, or the like. The external layer is a layer reinforcing the internal layer to give necessary mechanical strength to the member 10. The external layer can be formed of any of various resin materials and metal materials.

FIG. 2 illustrates dimensions of the container-shaped member 10. An inner diameter L1 of the side wall portion 13 of the container-shaped member 10 is, for example, but not particularly limited to, 30 to 50 mm. A diameter L2 of the through hole 12 is, for example, but not particularly limited to, 10 μm to 10 mm, preferably 100 μm to 10 mm, and more preferably 1 mm to 10 mm. When L2<L1 is established as exemplified above, the preform 1 is discharged as a fluid having a reduced diameter through the through hole 12. The diameter L2 of the through hole 12 may be larger or smaller than the diameter of the second opening portion 23 of the metallic member 20. However, the diameter L2 is preferably smaller than the diameter of the second opening portion 23 of the metallic member 20 to sufficiently reduce contact of the fluid of the preform 1 discharged from the through hole 12 with the metallic member 20. A height L3 of the container-shaped member 10 is, for example, but not particularly limited to, 100 to 300 mm. The thicknesses of the bottom 11 and the side wall portion 13 of the container-shaped member 10 are, for example, but not particularly limited to, 0.5 to 2 mm.

The container-shaped member 10 contains the preform 1. A side of the preform 1 is entirely in contact with an inner peripheral surface of the side wall portion 13 of the container-shaped member 10. A bottom surface of the preform 1 is in contact with the upper surface of the bottom 11 of the container-shaped member 10 except for a portion facing the through hole 12 and blocking an upper part of the through hole 12. The surfaces of the container-shaped member 10 with which the preform 1 is in contact are the inner surface 10i formed of the above-described material.

The preform 1 includes a resin for forming a core of a POF. The preform 1 may further include a resin for forming a clad in addition to the resin for forming a core. Specifically, the preform 1 may include a columnar first portion formed of the resin for forming a core and a cylindrical second portion including the resin for forming a clad and coating an outer circumference of the first portion. Hereinafter, the resin for forming a core may be referred to as “resin A” and the resin for forming a clad may be referred to as “resin B”. The resin(s) included in the preform, namely the resin A and/or the resin B, may include a halogen atom or, particularly a chlorine atom.

The resin A includes, for example, a polymer X including a halogen atom. Examples of the halogen atom include a chlorine atom and a fluorine atom, and a chlorine atom is preferred. The polymer X may or may not include a hydrogen atom. The hydrogen atom included in the polymer X may be a heavy hydrogen atom. The polymer X includes, for example, a chlorine compound or fluorine compound having a polymerizable double bond as a monomer. Examples of the chlorine compound having a polymerizable double bond include a (meth)acrylate compound including a chlorine atom. Specific examples of the (meth)acrylate compound including a chlorine atom include trichloroethyl (meth)acrylate, and trichloroethyl methacrylate is preferred. Examples of the fluorine compound having a polymerizable double bond include a (meth)acrylate compound including a fluorine atom, a dioxolane derivative including a polymerizable double bond and a fluorine atom, and an oxolane derivative including a polymerizable double bond and a fluorine atom. Specific examples of the (meth)acrylate compound including a fluorine atom include pentafluorophenyl (meth)acrylate, trifluoroethyl (meth)acrylate, and hexafluoroisopropyl (meth)acrylate.

Examples of the dioxolane derivative including a polymerizable double bond and a fluorine atom include a compound represented by the following formula (1).

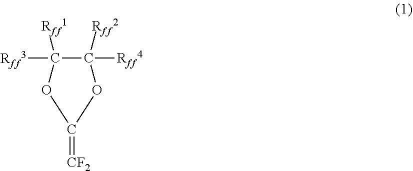

(In the formula (1), R_{ff}¹ to R_{ff}⁴ each independently represent a fluorine atom, a perfluoroalkyl group having 1 to 7 carbon atoms, or a perfluoroalkyl ether group having 1 to 7 carbon atoms. R_{ff}¹ and R_{ff}² may be linked to form a ring.)

Specific examples of the compound represented by the above formula (1) include compounds represented by the following formulae (A) to (H).

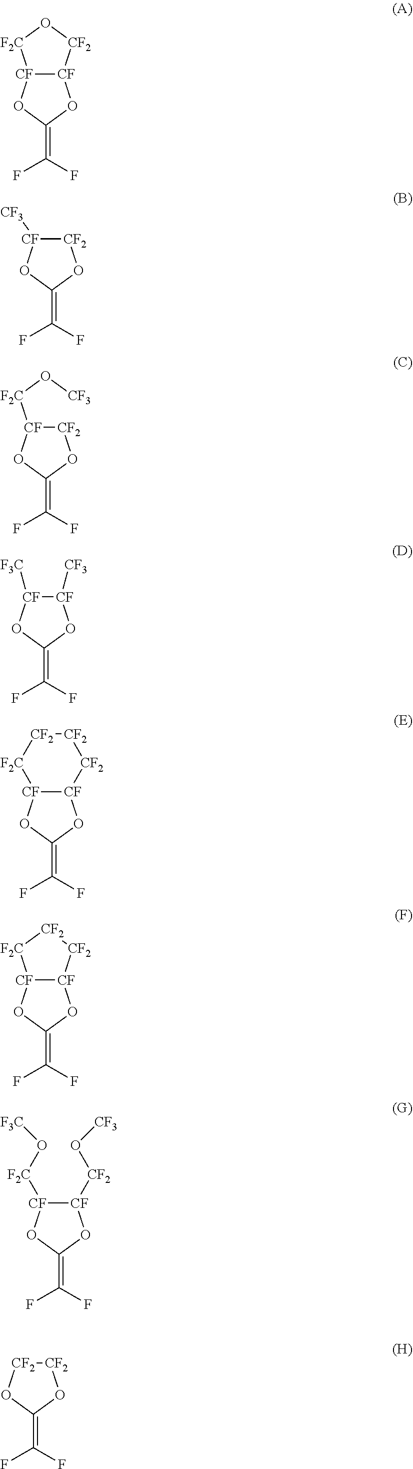

Among the compounds represented by the above formulae (A) to (H), a monomer forming the polymer X preferably includes the compound (B), i.e., a fluorine compound represented by the following formula (2), in terms of heat resistance.

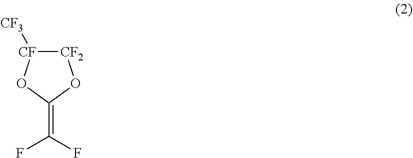

Examples of the oxolane derivative including a polymerizable double bond and a fluorine atom include a monomer for forming a polymer included in CYTOP (registered trademark) manufactured by AGC Inc.

The polymer X may further include a compound other than the above-described (meth)acrylate compounds as a monomer. Examples of the other compound include: (meth)acrylate compounds including no halogen atom, such as methyl (meth)acrylate, ethyl (meth)acrylate, n-propyl (meth)acrylate, n-butyl (meth)acrylate, cyclohexyl (meth)acrylate, and isobornyl (meth)acrylate; styrene compounds such as styrene, α-methylstyrene, fluorostyrene, pentafluorostyrene, chlorostyrene, and bromostyrene; vinyl ester compounds such as vinyl acetate, vinyl benzoate, vinylphenyl acetate, and vinylchloro acetate; maleimide compounds such as maleimide, N-cyclohexylmaleimide, N-methylmaleimide, N-n-butylmaleimide, N-tert-butylmaleimide, N-isopropylmaleimide, and N-phenylmaleimide; diester compounds having a polymerizable double bond, such as dicyclohexyl fumarate; nitrile compounds having a polymerizable double bond, such as acrylonitrile; heterocyclic compounds having a polymerizable double bond, such as 9-vinylcarbazole; and acid anhydrides having a polymerizable double bond, such as (meth)acrylic acid anhydride.

The resin A may include a polymer Y including no halogen atom instead of the polymer X or in addition to the polymer X. The polymer Y includes, for example, a hydrogen atom. The hydrogen atom included in the polymer Y may be a heavy hydrogen atom. The polymer Y includes, for example, a (meth)acrylate compound including no halogen atom as a monomer. Examples of the (meth)acrylate compound including no halogen atom include those described above for the polymer X. The polymer Y is, for example, polymethyl methacrylate.

The resin A may further include a refractive index modifier. The refractive index modifier is a compound having a higher refractive index than that of the polymer X or the polymer Y. Example of the refractive index modifier include: sulfur compounds such as diphenyl sulfone, diphenyl sulfone derivatives (for example, diphenyl sulfone chlorides such as 4,4′-dichlorodiphenyl sulfone and 3,3′,4,4′-tetrachlorodiphenyl sulfone), diphenyl sulfide, diphenyl sulfoxide, dibenzothiophene, and dithiane derivatives; phosphoric acid compounds such as triphenyl phosphate and tricresyl phosphate; and aromatic compounds such as benzyl benzoate, n-butyl benzyl phthalate, diphenyl phthalate, biphenyl, and diphenylmethane. The refractive index modifier is preferably diphenyl sulfoxide.

The resin B is a resin having a lower refractive index than that of the resin A. The resin B may include the same kind(s) of component(s) as the component(s) in the resin A. The resin B preferably includes the polymer Y including no halogen atom, and particularly preferably includes polymethyl methacrylate. The resin B may include the refractive index modifier, but preferably includes no refractive index modifier.

The preform 1 can be produced by placing a raw material of the resin in the container and reacting the raw material of the resin in the container.

The raw material of the resin may include a polymerization initiator in addition to the above-described monomer for forming the polymer X or the polymer Y, the refractive index modifier, etc. The polymerization initiator is, for example, a radical initiator. Examples of the radical initiator include: peroxide compounds such as benzoyl peroxide, t-butylperoxy-2-ethylhexanoate, di-t-butylperoxide, t-butylperoxy isopropyl carbonate, n-butyl4,4-bis(t-butylperoxy) valerate; and azo compounds such as 2,2′-azobisisobutyronitrile, 2,2′-azobis(2-methylbutyronitrile), 1,1′-azobis(cydohexane-1-carbonitrile), 2,2′-azobis(2-methylpropane), 2,2′-azobis(2-methylbutane), 2,2′-azobis(2-methylpentane), 2,2′-azobis(2,3-dimethylbutane), 2,2′-azobis(2-methylhexane), 2,2′-azobis(2,4-dimethylpentane), 2,2′-azobis(2,3,3-trimethylbutane), 2,2′-azobis(2,4,4-trimethylpentane), 3,3′-azobis(3-methylpentane), 3,3′-azobis(3-methylhexane), 3,3′-azobis(3,4-dimethylpentane), 3,3′-azobis(3-ethylpentane), dimethyl-2,2′-azobis(2-methylpropionate), diethyl-2,2′-azobis(2-methylpropionate), and di-t-butyl-2,2′-azobis(2-methylpropionate).

The raw material of the resin may further include a chain transfer agent. Examples of the chain transfer agent include: alkyl mercaptan compounds such as n-butyl mercaptan, n-pentyl mercaptan, n-octyl mercaptan, n-lauryl mercaptan, and t-dodecyl mercaptan; and thiophenol compounds such as thiophenol, m-bromothiophenol, p-bromothiophenol, m-toluenethiol, and p-toluenethiol.

The preform 1 can be produced, for example, by performing a polymerization reaction for yielding the polymer X or the polymer Y in the container. The polymerization reaction for yielding the polymer X or the polymer Y can be performed, for example, by heating the raw material, for example, to 50° C. to 150° C., preferably 85° C. to 132° C., and more preferably 87° C. to 130° C. under an atmosphere of an inert gas such as nitrogen. It is preferable that oxygen dissolved in the raw material is removed in advance from the raw material by degassing such as freeze-pump-thaw.

The container-shaped member 10 can be obtained by forming the through hole 12 at the bottom of the container after the production of the preform 1 in the container. The through hole 12 may be formed physically by applying an external force, by means of a local chemical reaction, or by a combination of these, depending on the material of the container, etc.

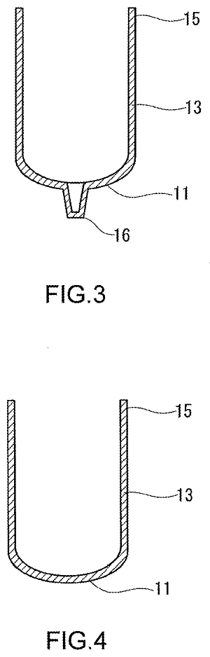

As shown in FIG. 3, a projecting portion 16 may be provided at a bottom 12 of a container 15 for easy formation of the through hole 12. The projecting portion 16 has the shape of, for example, a truncated cone or cone having a hollow communicating with an internal space of the container 15 and projects downward from the bottom 12. The through hole 12 is formed by entirely or partly removing the projecting portion 16. The projecting portion 16 can be easily removed, for example, by applying stress to a tip of the projecting portion 16 and breaking off the projecting portion 16. Dimensions of the projecting portion 16 can be set within certain ranges so that the removal of the projecting portion 16 and the polymerization for yielding the polymer X or the polymer Y can be performed easily. The maximum value of the outer diameter of the projecting portion 16 is, for example, 1 to 10 mm. The length of the projecting portion 16 is, for example, 5 to 20 mm. The projecting portion 16 makes it possible to specify the position and size of the through hole 12 in advance. The projecting portion 16 desirably projects further downward from a portion at the lowermost part of the bottom 11. However, the projecting portion 16 is not essential. The through hole 12 can be desirably formed also at the bottom 11 of the container 15 not having the projecting portion 16, as shown in FIG. 4, for example, by using a commercially-available drilling machine.

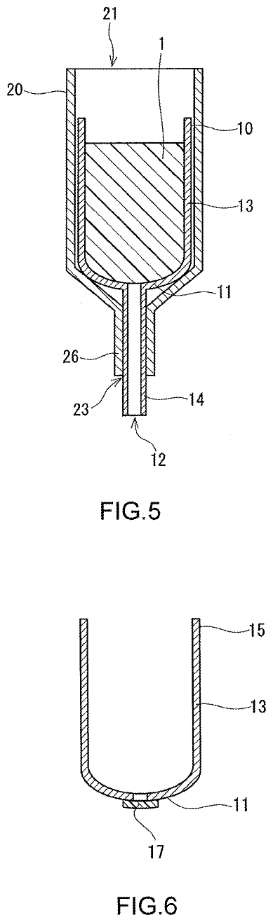

When the container 15 is disposed in the metallic member 20, the projecting portion 16 may be long enough that the tip thereof is inserted in a later-described second tubular portion 26 of the metallic member 20, that the tip thereof projects downward from the second opening portion 23, or that the tip thereof is inserted into a later-described first chamber 30 of a spinning apparatus 100. When only the tip of the projecting portion 16 is removed to form the through hole 12, the bottom 11 of the container-shaped member 10 has a tubular portion 14 derived from the projecting portion 16, as shown in FIG. 5. The longer tubular portion 14 can reduce more contact between the material of the preform 1 and the second tubular portion 26 of the metallic member 20. For example, in FIG. 5, the tubular portion 14 is inserted in the second tubular portion 26 of the metallic member 20 and a tip thereof projects downward from the second opening portion 23. The tubular portion 14 shown in FIG. 5 is particularly suitable for reducing contact of the material of the preform 1 with the metallic member 20. As described later, in the first chamber 30 of the spinning apparatus 100, the tubular portion 14 may extend to the vicinity of a position where the resin B for forming a clad and a formed body formed of the preform 1 meet.

The container-shaped member 10 containing the preform 1 is introduced into the metallic member 20 from the first opening portion 21 of the metallic member 20 and is disposed therein as shown in FIG. 1.

The metallic member 20 of a spinning apparatus includes a first tubular portion 25, the second tubular portion 26, and a tubular diameter-shrinking portion 22 connecting the first tubular portion 25 and the second tubular portion 26, and is tubular as a whole. The first tubular portion 25 and the second tubular portion 26 each have, for example, a cylindrical shape. The first tubular portion 25 has an inner diameter larger than an inner diameter of the second tubular portion 26. The diameter of the diameter-shrinking portion 22 shrinks from the first tubular portion 25 toward the second tubular portion 26. The side of the diameter-shrinking portion 22 has the shape of the side of a truncated cone. The container-shaped member 10 is in contact with the diameter-shrinking portion 22 and is supported by the metallic member 20 at the diameter-shrinking portion 22.

The metallic member 20 includes the first opening portion 21 formed at an end portion of the first tubular portion 25 and the second opening portion 23 formed at an end portion of the second tubular portion 26. The container-shaped member 10 is set in the metallic member 20 by inserting the container-shaped member 10 from the first opening portion 21 in the first tubular portion 25. In this state, the axial direction of the through hole 12 of the container-shaped member 10 and that of the second tubular portion 26 coincide with each other, and preferably the central axis of the through hole 12 and that of the second tubular portion 26 coincide with each other. The axial direction is preferably the vertical direction.

The preform 1 is softened and becomes able to flow by heating the preform 1 as in the state shown in FIG. 1. The softened preform 1 may be discharged from the inside of the container-shaped member 10 to the outside thereof through the through hole 12 using an atmospheric pressure difference between the first opening portion 21 and the second opening portion 23. Specifically, discharge of the preform 1 through the through hole 12 can be promoted by introducing an inert gas such as nitrogen from the first opening portion 21 into the metallic member 20 and pressing down an upper surface of the preform 1. Alternatively, without using the atmospheric pressure difference, the preform 1 can be heated to a temperature at which the viscosity of the preform 1 is sufficiently decreased. The material of the preform 1 discharged from the inside of the container-shaped member 10 to the outside thereof through the through hole 12 further passes through the second tubular portion 26 to be a fibrous formed body.

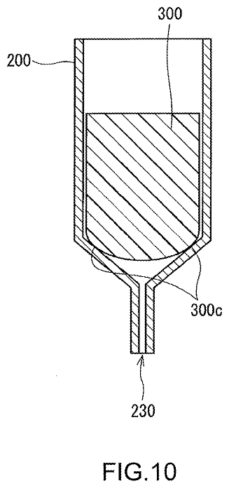

According to a method not involving a container-shaped member, as shown in FIG. 10, a peripheral portion 300c at a bottom of a preform 300 has close contact with a metallic member 200 for a long period of time. In the portion 300c, a resin is thermally deteriorated and an unwanted matter that is a factor of causing transmission loss tends to be generated. On the other hand, the preform 1 stays inside the container-shaped member 10 and does not have direct contact with the metallic member 20 until the preform 1 is heated and becomes able to flow. Therefore, the time during which the resin included in the preform 1 and the metallic member 20 are in contact can be drastically shortened compared to the case of not using the container-shaped member 10. The effect on reducing generation of an unwanted matter is significant when the resin included in the preform 1 includes a halogen atom, particularly a chlorine atom. The reducing effect is particularly significant when the resin included in the preform 1 includes a halogen atom and the metal material of the metallic member 20 includes iron. Examples of the iron-including metal material suitable for the metallic member 20 include stainless steel and HASTELLOY. The metallic member 20 is formed, for example, of a material including a metal other than aluminum as the main component.

Deposition of the deteriorated resin near an outlet (a second opening portion 230) of the metallic member 200 is a factor of changing the outer diameter of the resulting formed body. Additionally, in the case of performing melt spinning using an inert gas, the deteriorated resin deposits in a flow path of the resin to unnecessarily increase the internal pressure of the metallic member 200 and, in some cases, the inert gas blows from the metallic member 200. The use of the container-shaped member 10 is also effective in suppressing these troubles that can be caused by a deteriorated resin.

Surfaces of the preform 1 are in contact with the inner surface of the container-shaped member 10 and are not in contact with the external atmosphere, except for the upper surface of the preform 1 and a portion of a lower surface thereof facing the through hole. Therefore, the preform 1 contained in the container-shaped member 10 is advantageous also in terms of preventing the resin from being deteriorated by a reaction with an active species, such as oxygen, that sometimes enters or remains in the external atmosphere, compared to the preform 300 whose surfaces are all essentially in contact with the external atmosphere. Also in the case of introducing an inert gas to upper portions of the preforms 1 and 300 to press down the preforms 1 and 300, air remains inside the metallic member 20, and oxygen included in the air can react with the materials of the surfaces of the preforms 1 and 300. Therefore, even in the case of introducing the inert gas, covering the preform 1 with the container-shaped member 10 is advantageous also in terms of reducing partial oxidation of the surfaces of the preform. In the case where the preform 1 produced in a different container is taken out of the container and disposed inside the container-shaped member 10, there can be a small gap between the surfaces of the preform 1 and the inner surface of the container-shaped member 10. Even in this case, the preform 1 contained in the container-shaped member 10 has reduced contact with oxygen included in the external atmosphere, compared to the preform 300 whose surfaces are all essentially in contact with the external atmosphere. It should be noted that the preform 1 is preferably in close contact with the inner surface of the container-shaped member 10 in terms of sufficiently reducing contact with oxygen.

The heating for softening the preform 1 can be performed, for example, using a heater (not illustrated) installed near the diameter-shrinking portion 22 of the metallic member 20. In this case, the preform 1 contained in the member 10 is heated and softened by heat supplied from the metallic member 20 heated by the heater to a higher temperature. The heating temperature may be appropriately set according to the composition of the resin(s) (for example, the resin A) included in the preform 1, and is, for example, 100° C. to 250° C. The type, installation location, etc. of the heater are not particularly limited.

The formed body discharged from the second tubular body 26 is typically a fiber having a single-layer structure and being a core of a POF, but can be a fiber having a core-clad structure having a core and a clad coating the outer circumference of the core.

The diameter of the fibrous formed body is, for example, 300 μm or less, preferably 200 μm or less, and more preferably 150 μm or less. The lower limit of the diameter of the formed body is, for example, 10 μm. The diameter of the formed body can be adjusted by the diameter of the through hole 12, the internal pressure of the metallic member 20, the speed of winding the formed body, etc.

As described above, a preferred embodiment of the present invention is a method in which the preform 1 is heated while the preform 1 and the metallic member 20 in which the container-shaped member 10 is disposed are not in direct contact with each other, and the preform 1 softened thereby is caused to pass through the through hole 12 of the container-shaped member 10 and then through the tubular portion 26 of the metallic member 20 to shape the preform 1 into a fibrous shape. Moreover, a preferred embodiment of the present invention is a method in which the preform 1 is softened by applying heat to the preform 1 via the metallic member 20 while the preform 1 and the metallic member 20 in which the container-shaped member 10 is disposed are not in direct contact with each other. As described above, a heat source of the heat applied to the preform 1 via the metallic member 20 may be a heater installed independently of the metallic member 20. It should be noted that the container-shaped member 10 may not be disposed inside the metallic member 20 as long as the preform 1 can be softened and shaped into a fibrous shape.

Moreover, a preferred embodiment of the present invention is the method further including: reacting the raw material of the resin in the container 15 to produce the preform 1; and forming the through hole 12 in the container 15 to obtain the container-shaped member 10. However, the present invention is not limited to this and can be accomplished using a container whose through hole formed in advance is blocked by a sealing member. That is, another preferred embodiment of the present invention is the method further including: reacting the raw material of the resin in the container 15 having the through hole 12 blocked by a sealing member to produce the preform 1; and removing the sealing member from the container 15 to open the through hole 12 and obtain the container-shaped member 10.

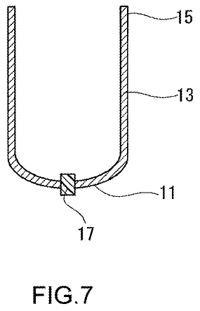

As shown in FIG. 6, a sealing member 17 may be a tape adhered to the bottom 11 of the container 15 so as to cover the through hole 12. As shown in FIG. 7, the sealing member 17 may be a plug inserted in the through hole 12.

The material of the sealing member 17 is not limited to a particular one, and examples thereof include the heat-resistant resins exemplified above, such as a polyimide and a fluorine resin. Preferred specific examples of the sealing member 17 shown in FIG. 6 include a polyimide tape and a PTFE tape.

The preferred embodiment in which the preform 1 is produced inside the container 15 eliminates the necessity of taking the preform 1 out of the container 15. Consequently, attachment of an unwanted matter such as dust in air to the preform 1 can be reduced. As a result, entrance of an unwanted matter to the resulting POF can be further reduced. Moreover, in this preferred embodiments, the container 15 is used as a reaction container for the raw material of the preform, even as a container for storing, transporting, and protecting the preform, and, after opening of the through hole, as a member for feeding the softened preform. Therefore, the series of steps can be effectively performed.

It should be noted that the manufacturing method of the present invention does not necessarily require the preform 1 to be produced inside the container 15. The preform 1 may be produced using a container different from the container 15. That is, another preferred embodiment of the present invention is the method further including: reacting the raw material of the resin in a container to produce the preform 1; and disposing the preform 1 taken out of the container in the container-shaped member 10.

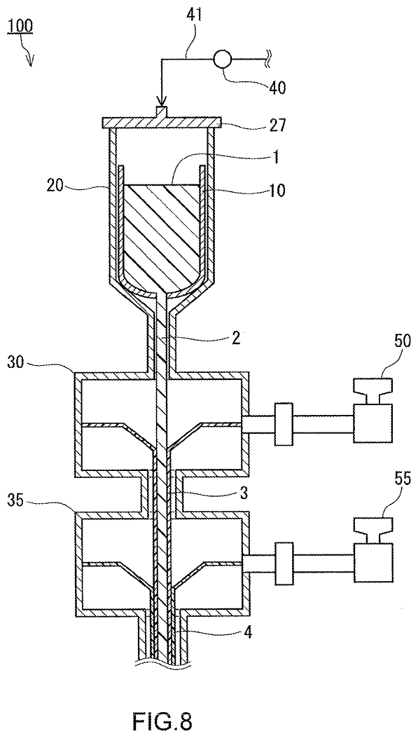

FIG. 8 shows a schematic cross-sectional view of the spinning apparatus 100 used for the POF manufacturing method of the present embodiment. This apparatus is an apparatus for obtaining a fibrous formed body as a core by causing the preform 1 to pass through the through hole and then coating the side of the formed body with another resin than the resin included in the formed body to form a clad. As shown in FIG. 8, the spinning apparatus 100 includes the metallic member 20, the first chamber 30, and a second chamber 35. The metallic member 20 is connected to the first chamber 30. The first chamber 30 is connected to the second chamber 35 through a pipe. The metallic member 20, the first chamber 30, and the second chamber 35 are, for example, arranged in this order downward in the vertical direction.

The first opening portion 21 of the metallic member 20 is closed by a lid 27. A pipe 41 is connected to the lid 27. An inert gas can be sent to the metallic member 20 through the pipe 41. The pipe 41 is equipped with a pump 40. The pressure of the inert gas can be increased by the pump 40. The internal pressure of the metallic member 20 is increased by sending the inert gas to the metallic member 20. As the internal pressure of the metallic member 20 increases, the preform 1 is pushed out of the container-shaped member 10, and a fibrous formed body 2 can thus be obtained. In the embodiment shown in FIG. 8, the formed body 2 is a core of a POF.

Next, the formed body 2 is sent to the first chamber 30. The first chamber 30 is equipped with a first resin feeder 50. The resin B for forming a clad can be fed into the first chamber 30 using the first resin feeder 50. The resin B may be molten in advance in the first resin feeder 50. In the first chamber 30, a clad 3 coating the outer circumference of the formed body 2 can be formed by coating the formed body 2 with the resin B.

Subsequently, the formed body 2 coated with the clad 3 is sent to the second chamber 35. The second chamber 35 is equipped with a second resin feeder 55. A resin for forming a coating layer (overclad) disposed around the outer circumference of the clad 3 can be fed into the second chamber 35 using the second resin feeder 55. A resin for forming a coating layer may be herein referred to as “resin C”. The resin C is not particularly limited as long as the resin C has sufficient mechanical strength and can be sufficiently closely in contact with the clad 3. The resin C includes, for example, a polycarbonate. The polycarbonate may be a polyester-modified polycarbonate such as XYLEX X7200 manufactured by SABIC Innovative Plastics. The resin C may be molten in advance in the second resin feeder 55. A coating layer 4 coating the outer circumference of the clad 3 can be formed by coating the clad 3 with the resin C in the second chamber 35.

The formed body 2 coated with the coating layer 4 may further be subjected to heating treatment. In the case where the resin A includes the refractive index modifier, the heating treatment can spread the refractive index modifier from the formed body 2 toward the clad 3. The spinning apparatus 100 may further include, downstream of the second chamber 35, a pipe (heating path) equipped with a heater for heating the formed body 2. The formed body 2 can be subjected to the heating treatment by sending the formed body 2 into this pipe.

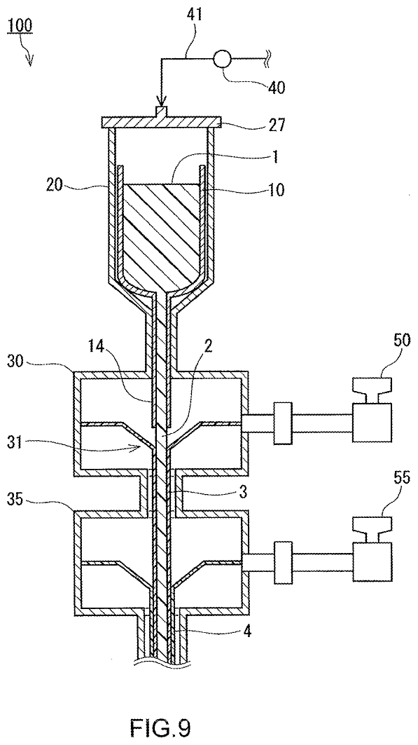

As described above, the container-shaped member 10 has the tubular portion 14 derived from the projecting portion 16 in some cases. FIG. 9 shows a schematic cross-sectional view of the spinning apparatus 100 in which the container-shaped member 10 having the tubular portion 14 is disposed. In FIG. 9, the tip of the tubular portion 14 is inserted into the first chamber 30 of the spinning apparatus 100. In the first chamber 30 of the spinning apparatus 100, the tubular portion 14 extends to the vicinity of a position 31 where the resin B and the formed body 2 meet. Attachment of an unwanted matter to the formed body 2 can be further reduced owing to the tubular portion 14 extending to the vicinity of the position 31.

Since deterioration of the resin included in the preform 1 is sufficiently reduced according to the manufacturing method of the present embodiment, a POF produced by the manufacturing method includes almost no unwanted matters such as a deteriorated product of the resin. Whether the POF includes an unwanted matter or not can be determined using an optical microscope. The number of unwanted matters in the POF produced by the manufacturing method of the present embodiment, particularly in the core of the POF, is, for example, 10 or less, preferably 5 or less, and particularly preferably 0 per meter of the POF.

The POF manufactured by the manufacturing method of the present embodiment includes almost no unwanted matters, and thus the transmission loss thereof tends to be low. A transmission loss of the POF manufactured by the manufacturing method of the present embodiment for 780 nm light is, for example, 600 dB/km or less, preferably 500 dB/km or less, and more preferably 400 dB/km or less. The transmission loss of the POF for light with a wavelength of 780 nm can be measured by the following method according to a cut-back method defined in JIS C 6823: 2010. First, a 20-meter-long measurement POF is prepared. Light with a wavelength of 780 nm is introduced to an input end of the POF, and power P2 of light emitted from an output end of the POF is measured. Next, the POF is cut to a cutback length of two meters (i.e., at two meters away from the input position). Light with a wavelength of 780 nm is introduced to an input end of the two-meter-long POF, and power P1 of light emitted from an output end of the POF is measured. That is, the output light power P1 is measured for the measurement POF having the cutback length. The transmission loss is calculated by the following equation on the basis of the measurement results. In the following equation, A represents a transmission loss (dB/km) per kilometer of the POF. L represents the length (km) (i.e., 0.018 km) of the cut POF.

A=10×log(P1/P2)/L

### EXAMPLES

Hereinafter, the present invention will be described in more detail with reference to Examples and Comparative Example. However, the present invention is not limited to Examples.

### Example 1

First, 280 g of trichloroethyl methacrylate (TCEMA) purified by distillation, 8.7 g of cyclohexylmaleimide, and 12.05 g of diphenyl sulfoxide (DPSO) as a refractive index modifier were added to a 500 mL container made of a tetrafluoroethylene-perfluoroalkyl vinyl ether copolymer (PFA) and were stirred and dissolved to obtain a solution. To the solution were added 115 μL of di-t-butyl peroxide as a polymerization initiator and 520 μL of n-lauryl mercaptan as a chain transfer agent. The resulting mixture was subjected to filtration using a membrane filter having a pore size of 0.2 μm and then to filtration using a membrane filter having a pore size of 0.1 μm.

Next, the filtrate was added to a container having a shape as shown in FIG. 3. The container was made of glass and had a cylindrical side wall portion. The side wall portion of the container had an outer diameter of 38 mm. A bottom of the container had a projecting portion. The maximum value of the outer diameter of the projecting portion was 5 mm, and the length of the projecting portion was 10 mm. Next, a lid made of SUS was disposed on the container. The lid was provided with an opening for introducing nitrogen into the container therethrough and an opening for reducing the pressure in the container using a vacuum pump. Subsequently, the filtrate was subjected to three cycles of freeze-pump-thaw to remove dissolved oxygen in the filtrate. The freeze-pump-thaw was performed by the following method. First, the bottom of the container was soaked in liquid nitrogen to freeze the filtrate, and then the pressure inside the container was decreased to about 0.1 kPa. After that, the bottom of the container was soaked in ethanol or water to increase the temperature of the filtrate to room temperature and thaw the filtrate.

After the freeze-pump-thaw, the atmosphere in the container was replaced with nitrogen. Then, the container was disposed in a dryer and heated at 85° C. to 130° C. for 30 hours to cause a polymerization reaction. A preform was thus obtained. After the polymerization reaction, the projecting portion of the container was cut off. A through hole having a diameter of about 5 mm was thus formed at the bottom of the container. Next, the resulting container-shaped member was set in a metallic member of a spinning apparatus without taking the preform out of the container-shaped member. A first tubular portion of the metallic member had an inner diameter of 40 mm.

The spinning apparatus included a first resin feeder for feeding a resin for forming a clad and a second resin feeder for feeding a resin for forming a coating layer. Polymethyl methacrylate (PMMA) (ACRYPET manufactured by Mitsubishi Chemical Corporation) was used as the resin for forming a clad. A polyester-modified polycarbonate (PC) (XYLEX X7200 manufactured by SABIC Innovative Plastics) was used as the resin for forming a coating layer.

Next, a bottom of the container-shaped member set in the metallic member was heated to 150° C. to melt the preform. Nitrogen was introduced into the metallic member to extrude the preform from the container-shaped member. A fibrous formed body was thus obtained. Subsequently, the PMMA was fed from the first resin feeder to coat the formed body with a clad made of the PMMA. Then, the PC was fed from the second resin feeder to coat the clad with a coating layer made of the PC. Then, the formed body was sent to a pipe equipped with a heater and subjected to heating treatment. A POF of Example 1 having a core, a clad, and a coating layer was thus obtained. In the POF, the refractive index modifier included in the core spread from the core toward the clad. The core of the POF of Example 1 had a diameter of about 100 μm. The clad had an outer diameter of about 240 μm. The coating layer had an outer diameter of about 470 μm.

Next, the POF of Example 1 was evaluated for a transmission loss for 780 nm light and the presence or absence of an unwanted matter in the core. The transmission loss of the POF of Example 1 for 780 nm light was measured by the above method. FOLS-01 manufactured by Craft Center SAWAKI Inc. was used as a light emitting apparatus for introducing light to the POF. Power of light emitted from an output end of the POF was measured using 8230 manufactured by ADC CORPORATION. The transmission loss of the POF of Example 1 for 780 nm light was 320 dB/km.

The presence or absence of an unwanted matter in the core of the POF of Example 1 was determined by observing a one-meter-long core of the POF of Example 1 using an optical microscope. When one or more unwanted matters were confirmed in the core, the number of the unwanted matters was counted. No unwanted matters were confirmed in the core of the POF of Example 1.

### Example 2

A POF of Example 2 was obtained in the same manner as in Example 1, except that a container having a shape as shown in FIG. 6 was used instead of the container having a shape as shown in FIG. 3. A through hole having a diameter of 5 mm was arranged at the bottom of the container. The through hole was blocked by a polyimide tape. In Example 2, the polyimide tape was removed from the container after the polymerization reaction, and the resulting container-shaped member was set in a metallic member of a spinning apparatus. The POF of Example 2 was evaluated for the transmission loss and so on in the same manner as in Example 1. Table 1 shows the results.

### Example 3

A POF of Example 3 was obtained in the same manner as in Example 1, except that a container having a shape as shown in FIG. 4 was used instead of the container having a shape as shown in FIG. 3. In Example 3, a through hole was formed at the bottom of the container after the polymerization reaction, and the resulting container-shaped member was set in a metallic member of a spinning apparatus. The POF of Example 3 was evaluated for the transmission loss and so on in the same manner as in Example 1. Table 1 shows the results.

### Example 4

A POF of Example 4 was obtained in the same manner as in Example 3, except that the container used was made of polytetrafluoroethylene (PTFE). Moreover, the POF of Example 4 was evaluated for the transmission loss and so on in the same manner as in Example 1. Table 1 shows the results.

### Example 5

A POF of Example 5 was obtained in the same manner as in Example 3, except that the container used was made of aluminum. Moreover, the POF of Example 5 was evaluated for the transmission loss and so on in the same manner as in Example 1. Table 1 shows the results.

### Example 6

A POF of Example 6 was obtained in the same manner as in Example 1, except that a container having a shape as shown in FIG. 7 was used instead of the container having a shape as shown in FIG. 3 and the container was changed to a container made of PTFE. A through hole having a diameter of 5 mm was arranged at the bottom of the container. A plug made of PTFE was inserted in the through hole. In Example 6, the plug made of PTFE was removed from the container after the polymerization reaction, and the resulting container-shaped member was set in a metallic member of a spinning apparatus. The POF of Example 6 was evaluated for the transmission loss and so on in the same manner as in Example 1. Table 1 shows the results.

### Example 7

A POF of Example 7 was obtained in the same manner as in Example 6, except that the container used was made of aluminum. Moreover, the POF of Example 7 was evaluated for the transmission loss and so on in the same manner as in Example 1. Table 1 shows the results.

### Comparative Example 1

After the polymerization reaction was performed in the same manner as in Example 1, the container was broken to obtain a columnar preform. The preform had a diameter of 38 mm and a length of 190 mm. Then, a POF of Comparative Example 1 was produced in the same manner as in Example 1, except that the preform was directly set in a metallic member of a spinning apparatus. Moreover, the POF of Comparative Example 1 was evaluated for the transmission loss and so on in the same manner as in Example 1. Table 1 shows the results.

TABLE 1

| | | | Transmission | Number of |
|---|---|---|---|---|
| | Material of | | loss for 780 nm | unwanted matters |
| | container | Shape of container | light (dB/km) | (per meter) |
| Example 1 | Glass | Having through hole | 320 | 0 |
| | | formed after polymerization | | |
| | | (With projecting portion) | | |
| Example 2 | Glass | Sealed with sealing | 330 | 0 |
| | | member (tape) | | |
| Example 3 | Glass | Having through hole | 330 | 0 |
| | | formed after polymerization | | |
| | | (Without projecting portion) | | |
| Example 4 | PTFE | Having through hole | 340 | 0 |
| | | formed after polymerization | | |
| | | (Without projecting portion) | | |
| Example 5 | Aluminum | Having through hole | 330 | 0 |
| | | formed after polymerization | | |
| | | (Without projecting portion) | | |
| Example 6 | PTFE | Sealed with sealing | 340 | 0 |
| | | member (plug) | | |
| Example 7 | Aluminum | Sealed with sealing | 330 | 0 |
| | | member (plug) | | |
| Comparative | — | — | 820 | 15 |
| Example 1 | | | | |

As can be understood from Table 1, because the preform was in direct contact with the metallic member of the spinning apparatus in Comparative Example 1, there were a lot of unwanted matters in the core of the resulting POF. On the other hand, as can be understood from Examples 1 to 7, a POF having almost no unwanted matters in the core can be produced by the manufacturing method of the present embodiment. The results of Examples and Comparative Example reveal that a POF having almost no unwanted matters in the core can greatly reduce the transmission loss for 780 nm light.

### INDUSTRIAL APPLICABILITY

A POF produced by the manufacturing method of the present embodiment is suitably used for high-speed communication.

1. A plastic optical fiber manufacturing method comprising causing a preform that is softened to pass from an inner side of a container-shaped member having a shape of a container having a through hole at a bottom thereof through the through hole, wherein
the preform includes a resin, and
at least an inner surface of the container-shaped member is formed of a material including glass, a heat-resistant resin, or aluminum as a main component.

2. The plastic optical fiber manufacturing method according to claim 1, wherein the container-shaped member includes glass as a main component.

3. The plastic optical fiber manufacturing method according to claim 1, wherein the container-shaped member includes a heat-resistant resin as a main component, and
the heat-resistant resin is a fluorine resin.

4. The plastic optical fiber manufacturing method according to claim 1, further comprising:
reacting a raw material of the resin in a container to produce the preform; and
forming the through hole in the container to obtain the container-shaped member.

5. The plastic optical fiber manufacturing method according to claim 1, further comprising:
reacting a raw material of the resin in a container having a through hole blocked by a sealing member to produce the preform; and
removing the sealing member from the container to obtain the container-shaped member.

6. The plastic optical fiber manufacturing method according to claim 1, further comprising:
reacting a raw material of the resin in a container to produce the preform; and
disposing the preform taken out of the container in the container-shaped member.

7. The plastic optical fiber manufacturing method according to claim 1, wherein
the preform is heated while the preform and a metallic member in which the container-shaped member is disposed are not in direct contact with each other, and
the preform softened thereby is caused to pass through the through hole and then through a tubular portion of the metallic member to shape the preform into a fibrous shape.

8. The plastic optical fiber manufacturing method according to claim 1, wherein the preform is softened by applying heat to the preform via a metallic member while the preform and the metallic member in which the container-shaped member is disposed are not in direct contact with each other.

9. The plastic optical fiber manufacturing method according to claim 7, wherein
the metallic member is a tubular member including a first tubular portion, a second tubular portion, and a tubular diameter-shrinking portion connecting the first tubular portion and the second tubular portion,
the first tubular portion has an inner diameter larger than an inner diameter of the second tubular portion, and
the preform is softened while the container-shaped member is supported by the metallic member at the diameter-shrinking portion.

10. The plastic optical fiber manufacturing method according to claim 7, wherein the metallic member includes a metal other than aluminum as a main component.

11. The plastic optical fiber manufacturing method according to claim 1, further comprising coating a side of a fibrous formed body obtained by causing the preform to pass through the through hole with another resin than the resin.
